(19) United States
(12) Patent Application Publication
(10) Pub. No.: US 2005/0158666 A1
(43) Pub. Date: Jul. 21, 2005

(54) Lateral etch inhibited multiple etch method for etching material etchable with oxygen containing plasma

(75) Inventors: Jen-Cheng Liu, Chin-Yih City (CN); Shu-Chih Yang, Hsin-Chu (CN); Hun-Jan Tao, Hsin-Chu (CN); Chia-Shiung Tsai, Hsin-Chu (CN)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (CN)

(21) Appl. No.: 11/037,787

(22) Filed: Jan. 18, 2005

Related U.S. Application Data
(63) Continuation of application No. 09/419,105, filed on Oct. 15, 1999, now abandoned.

(51) Int. Cl. G03C 5/00

(52) U.S. Cl. 430/314; 430/313

(57) ABSTRACT

A method for etching a pattern within a dual-layer stack dielectric layer employed within a microelectronics fabrication. A first low dielectric constant dielectric layer employing HSQ polymer spin-on-glass (SOP) dielectric material is formed over a substrate. A second dielectric layer is then provided to form a dual level dielectric stack layer. There is then formed over the dual dielectric layer a patterned photoresist etch mask layer. The pattern is transferred into and through the dielectric stack layer employing an anisotropic reactive ion etching environment to etch the pattern through the patterned photoresist etch mask layer. There is then added to the etchant environment additional gases under conditions to form a plasma in the final etching environment to stabilize the etched pattern surface and attenuate degradation of the etched pattern during subsequent stripping of the photoresist etch mask pattern.

### RELATED APPLICATION

This application is a continuation of U.S. patent application Ser. No. 09/419,105 filed Oct. 15, 1999, and entitled, “Lateral Etch Inhibited Multiple Etch Method for Etching Material Etchable,” which is hereby incorporated by reference in its entirety.

### BACKGROUND OF THE INVENTION

1. Field of the Invention

The invention relates to the field of dielectric layers employed within microelectronics fabrications. More particularly, the invention relates to the etching of dielectric layers and the removal of photoresist etch mask residues employed therein in microelectronics fabrications.

2. Description of the Related Art

The fabrication of microelectronics devices employs surface layers of materials deposited upon substrates and fashioned into patterns to form the substructures of the final microelectronics fabrication. An essential part of the fabrication process is that of photolithography, wherein finely-detailed patterns are transferred optically from precisely formed master photomask patterns to the desired surface layers by means of light-sensitive surface coatings known as photoresists. Organic polymer substances with enhanced light sensitivity are commonly employed as photoresists, formed on the surfaces of material layers, exposed to light with the appropriate mask pattern, and developed to form a corresponding surface pattern which may then serve as an etching mask for further transfer of the pattern into the underlying layer of material.

Microelectronics fabrications are built up from multiple layers of materials, many of which must be formed into patterns employing the aforementioned method of photolithography. It is usually necessary to remove the photoresist mask pattern layer after use so as not to interfere with subsequent fabrication processes. Many methods are available for removal or stripping of photoresist layer residues as well as other process residues from microelectronics fabrications undergoing manufacture. Both wet chemical methods and dry or gas phase methods have been developed. A common method known as dry plasma ashing employs various combinations of oxidizing gases and vapors in which an electrical plasma produces activated species which react with the organic polymers of the photoresist and other residual materials to form volatile products to remove the polymer materials more or less completely. In order to ensure complete removal of organic material residues, a wet chemical solvent stripping agent such as PRS (Photo-Resist-Strip) is often employed.

While plasma ashing combined with solvent methods are in general satisfactory for removal of photoresist residues, they are not without problems. In particular, the employment of low dielectric constant dielectric materials as part of multi-level stack dielectric layers such as inter-level metal dielectric (IMD) layers may involve the use of, for example, organic polymer spin-on-polymer (SOP) dielectric material and silicon containing dielectric material such as hydrogen silsesquioxane (HSQ) spin-on-glass (SOG) dielectric and methylsilsesquioxane (MSQ) spin-on-glass (SOG) dielectric material, which are often subject to attack by dry plasma ashing and/or wet chemical methods for stripping photoresist layers and cleaning.

It is therefore towards the goal of providing improved methods for forming etched patterns with attenuated degradation by stripping/cleaning processes that the present invention is generally directed.

Various methods have been disclosed for forming etched patterns in HSQ dielectric glass layers.

For example, Cho, in U.S. Pat. No. 5,656,555, discloses a method for employing modified hydrogen silsesquioxane (HSQ) dielectric material precursors to form dielectric layers which exhibit repeatable dielectric properties during and after curing due to inhibited oxidation and/or water absorption than unmodified HSQ dielectric materials under comparable conditions. The modifying agents comprise alkyl alkoxysilanes, fluorinated alkyl alkoxysilanes and combinations thereof with the HSQ spin-on-glass (SOG) in the precursor dielectric materials.

Further, Nishimura et al, in U.S. Pat. No. 5,728,630, disclose a method for forming with enhanced reliability a multi-level dielectric layer over patterned conductors with a planar surface. The method employs a silicon-containing ladder polymer dielectric material formed between silicon oxide dielectric layers.

Still further, Houston, in U.S. Pat. No. 5,795,810, discloses a method for forming low dielectric constant dielectric layers over silicon on insulator (SOI) substrates as inter-level metal dielectric layers with reduced wiring capacitance. The method employs hydrogen silsesquioxane (HSQ) low dielectric constant spin-on-glass (SOG) dielectric material to form the low dielectric constant dielectric layers.

Finally, Ahlburn et al., in U.S. Pat. No. 5,607,773, disclose a method for forming a dielectric layer requiring fewer processing steps and providing a lower dielectric constant in a inter-level metal dielectric layer. The method employs first and third layers of silicon oxide and an intermediate layer of silicon containing dielectric material formed from hydrogen silsesquioxane (HSQ) spin-on-glass (SOG) dielectric material.

Desirable in the art of microelectronics fabrication are additional methods for etching patterns and subsequent stripping of photoresist mask layers without damage to etched pattern features in HSQ dielectric layers.

It is towards these goals that the present invention is generally and more specifically directed.

### SUMMARY OF THE INVENTION

A first object of the present invention is to provide a method for etching dielectric layers etchable in an oxygen containing plasma employed in microelectronics fabrications with attenuated subsequent degradation during stripping of the photoresist mask layers formed in the microelectronics fabrication.

A second object of the present invention is to provide a method in accord with the first object of the present invention, where there is etched an inter-level metal dielectric (IMD) layer comprising a dielectric sub-layer formed of silsesquioxane (SQ) spin-on-glass (SOG) dielectric material with reduced inter-level capacitance to provide attenuated degradation from subsequent photoresist stripping employing dry plasma ashing and chemical methods.

A third object of the present invention is to provide a method in accord with the first object of the present and/or the second object of the present invention, where the invention is readily commercially implemented.

In accord with the objects of the present invention, there is provided a method for etching HSQ dielectric layers employed within a microelectronics fabrication with attenuated degradation after etching from photoresist stripping operations. To practice the method of the present invention, there is first provided a substrate. There is then formed over the substrate a low dielectric constant dielectric layer employing silsesquioxane (HSQ) dielectric spin-on-glass (SOG) material. There is then formed over the HSQ dielectric layer a second dielectric layer to form a dual level dielectric layer stack layer. There is then formed over the dielectric layer stack layer a patterned photoresist etch mask layer. The pattern is transferred into and through the dielectric layer stack layer employing a reactive ion subtractive etching environment to etch the pattern through the patterned photoresist etch mask layer. Near the end of the etching cycle, there is added to the etchant environment additional gases under conditions so as to form a plasma in the gas mixture, which enhances the resistance of the etched pattern of the dielectric layer stack layer and attenuates degradation of the dielectric layer during subsequent stripping of the photoresist etch mask layer employing dry plasma ashing and chemical methods.

The method of the present invention employs methods and materials as are known in the art of microelectronics fabrication, but in a novel order and arrangement. The method of the present invention is therefore readily commercially implemented.

### BRIEF DESCRIPTION OF THE DRAWINGS

The objects, features and advantages of the present invention are understood within the context of the Description of the Preferred Embodiments, as set forth below. The Description of the Preferred Embodiments is understood within the context of the accompanying drawings, which form a material part of this disclosure, wherein:

FIG. 1, FIG. 2, FIG. 3 and FIG. 4 are directed towards a general embodiment of the present invention which constitutes a first preferred embodiment of the present invention. Shown in FIG. 1 to FIG. 4 are a series of schematic cross-sectional diagrams illustrating the results of etching through a dual layer stack dielectric layer formed upon a substrate employed within a microelectronics fabrication in accord with a first preferred embodiment of the present invention to provide a pattern with attenuated degradation due to subsequent stripping of a patterned photoresist etch mask layer employing dry plasma ashing and chemical methods.

FIG. 5, FIG. 6, FIG. 7, FIG. 8 and FIG. 9 are directed towards a more specific embodiment of the present invention which constitutes a second preferred embodiment of the present invention. Shown in FIG. 5 to FIG. 9 are a series of schematic cross-sectional diagrams illustrating the results of etching through an inter-level metal dielectric (IMD) layer having reduced inter-level capacitance formed over a substrate employed within an integrated circuit microelectronics fabrication in accord with a second preferred embodiment of the present invention to provide an etched pattern with attenuated degradation during subsequent photoresist etch mask layer stripping employing dry plasma ashing and chemical methods.

### DESCRIPTION OF THE PREFERRED EMBODIMENTS

The present invention provides a method for forming upon a substrate employed within a microelectronics fabrication an etched pattern within a dual layer stack dielectric layer formed employing low dielectric constant spin-on-polymer (SOP) and/or spin-on-glass (SOG) dielectric materials with attenuated degradation due to subsequent stripping of patterned photoresist etch mask layer employing plasma ashing and wet chemical methods.

### First Preferred Embodiment

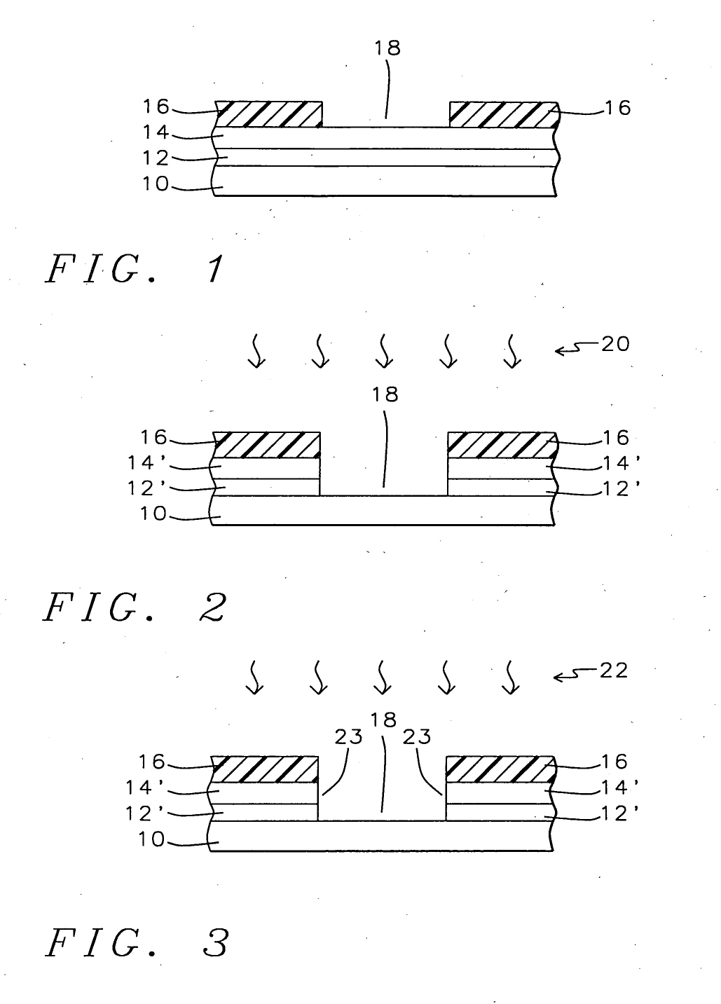

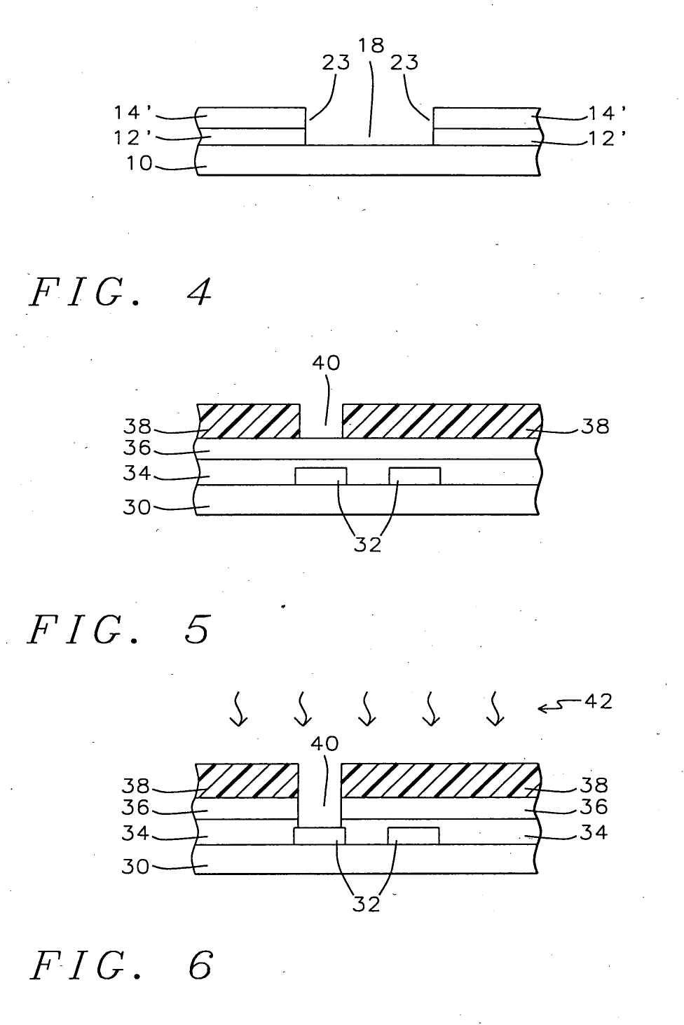

Referring now more particularly to FIG. 1 to FIG. 4, there is shown the results of etching, within a dual layer stack dielectric layer formed over a substrate employed within a microelectronics fabrication, a pattern employing a patterned photoresist etch mask layer with attenuated degradation due to subsequent stripping of the photoresist mask layer. Shown in FIG. 1 is a schematic cross-sectional diagram of a microelectronics fabrication at an early stage in its fabrication in accord with a first preferred embodiment of the present invention.

Shown in FIG. 1 is a substrate 10 upon which is formed a first dielectric layer 12 and a second dielectric layer 14 to form a dual layer stack dielectric layer. Formed over the dual layer stack dielectric layer is a photoresist etch mask layer 16 formed into a pattern 18.

With respect to the substrate 10 shown in FIG. 1, the substrate 10 may be a substrate employed within a microelectronics fabrication selected from the group including but not limited to integrated circuit microelectronics fabrications, charge coupled device microelectronics fabrications, solar cell microelectronics fabrications, ceramic substrate microelectronics fabrications and flat panel display microelectronics fabrications. The substrate 10 may be the substrate itself employed within the microelectronics fabrication, or alternatively it may incorporate several microelectronics layers formed upon the substrate, employing materials including but not limited to microelectronics conductor materials, microelectronics semiconductor materials and microelectronics dielectric materials, and employing methods which are known in the art of microelectronics fabrication including but not limited to vacuum evaporation, electron beam evaporation, physical vapor deposition (PVD) sputtering, reactive sputtering, chemical vapor deposition (CVD), electrodeposition (ED) and chemical reaction. Preferably, the substrate 10 comprises a silicon semiconductor substrate.

With respect to the first dielectric layer 12 shown in FIG. 1, the first dielectric layer 12 is a low dielectric constant dielectric layer which forms the lower layer of dual layer stack dielectric layer. The first dielectric layer 12 may be formed employing a low dielectric constant silsesquioxane (SQ) spin-on-glass (SOG) dielectric material or a spin-on-polymer (SOP) dielectric material. Preferably the low dielectric constant dielectric layer 12 is formed employing a hydrogen silsesquioxane (HSQ) spin-on-glass (SOG) dielectric material, formed to a thickness of from about 4000 to about 5000 angstroms.

With respect to the second dielectric layer 14 shown in FIG. 1, the second dielectric layer 14 is a silicon containing dielectric layer. Preferably, the second dielectric layer 14 is formed employing plasma enhanced chemical vapor deposition (PECVD) from silane (CH₄) vapor and a mixture of oxygen and nitrogen gases as is known in the art of microelectronics fabrication to form a silicon oxide dielectric layer.

With respect to the patterned photoresist etch mask layer 16 formed into the pattern 18 shown in FIG. 1, the patterned photoresist mask layer 16 is formed employing photolithographic methods and materials as are known in the art of microelectronics fabrication.

Referring now more particularly to FIG. 2, there is shown a schematic cross-sectional diagram illustrating the results of further processing of the microelectronics fabrication whose schematic cross-sectional diagram is shown in FIG. 1 in accord with the first preferred embodiment of the present invention. Shown in FIG. 2 is a microelectronics fabrication otherwise equivalent to the microelectronics fabrication shown in FIG. 1, but where there has been etched the pattern 18 of the patterned photoresist etch mask layer 16 into and through the second dielectric layer 14′ and the first dielectric layer 12′ employing the anisotropic reactive ion etching environment 20.

With respect to the anisotropic reactive etching environment 20 shown in FIG. 2, the anisotropic reactive etching environment 20 is formed employing perfluorobutene (C₄F₈) vapor and a mixture of nitrogen, carbon monoxide and argon gases.

Referring now more particularly to FIG. 3, there is shown a schematic cross-sectional diagram illustrating the results of further processing of the microelectroncs fabrication whose schematic cross-sectional diagram is shown in FIG. 2 in accord with the first preferred embodiment of the present invention. Shown in FIG. 3 is a microelectronics fabrication otherwise equivalent to the microelectronics fabrication shown in FIG. 2, but where there has been added to the etching environment 20 of FIG. 2 additional gases to constitute a modified etching environment 22, and the etching process continued until completion, with formation of the passivated surfaces 23 of the etched pattern 18.

With respect to the additional gases which constitute the modified etching environment 22, the additional gases are added at a point of about 1 minute to about 1 minute 30 seconds before the end of the etching process, to cause a period of about 30 seconds to about 60 seconds of treatment of the substrate to the modified etching environment 22 before the end point The end point of the of the etching process may be determined by the monitoring of the silicon-oxygen (Si—O) and carbon-nitrogen (C—N) interface signal due to the onset in the formation of C—N at the underlying surface when the etching reaction is completed.

With respect to the added gases which produce the modified etching environment 22, the added gases are selected from combinations consisting of: (1) argon; (2) nitrogen; (3) argon/nitrogen; (4) oxygen/argon. Preferably, the added gases are argon and nitrogen employed under the following conditions: (1) nitrogen about 100 standard cubic centimeters per minute (sccm)+argon about 100 standard cubic centimetrs per minute (sccm); (2) pressure about 40 mTorr; (3) power about 500 watts; (4) temperature about 60 degrees centigrade; (5) time about 20 seconds.

Referring now more particularly to FIG. 4, there is shown a schematic cross-sectional diagram illustrating the results of final processing of the microelectronics fabrication whose schematic cross-sectional diagram is shown in FIG. 3 in accord with the first preferred embodiment of the present invention. Shown in FIG. 4 is a microelectronics fabrication otherwise equivalent to the microelectronics fabrication shown in FIG. 3, but where there has been stripped the photoresist etch mask layer 14. The surfaces 23 of the etched pattern 18 formed employing the added gases environment 22 have become passivated and exhibit attenuated degradation during subsequent stripping of the photoresist etch mask layer.

With respect to the stripping of the photoresist etch mask layer 14, the stripping process employs the following process conditions: (1) oxygen gas; (2) power about 1000 to about 1500 watts; (3) temperature about 100 degrees centigrade; (4) pressure about 40 to about 80 milliTorr. Any degradation of the dielectric layer within which the etched pattern 18 is formed is attenuated by the presence of the passivation surface layer 23.

### Second Preferred Embodiment

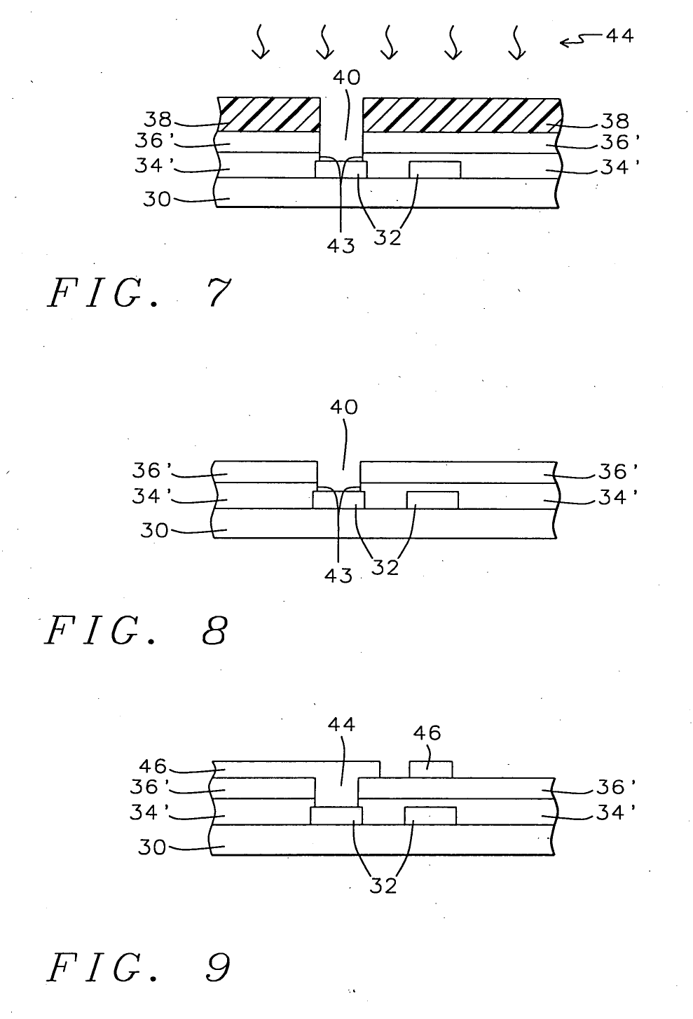

Referring now more particularly to FIG. 5 to FIG. 9, there is shown a series of schematic cross-sectional diagrams illustrating the results of etching within an inter-level metal dielectric (IMD) layer with reduced inter-level capacitance formed upon a substrate employed within an integrated circuit microelectronics fabrication a pattern employing etching conditions to provide attenuated degradation to the etched pattern by subsequent stripping of the photoresist etch mask layer employing plasma etching and chemical methods. FIG. 5 shows a schematic cross-sectional diagram of an integrated ciruit microeelctronics fabrication at an early stage of its fabrication in accord with a second preferred embodiment of the present invention.

Shown in FIG. 5 is a semiconductor substrate 30 having formed over it a microelectronics patterned layer 32. Formed over the substrate is a planar blanket first dielectric layer 34. Formed over the first blanket planar dielectric layer is a second dielectric layer 36 to form an inter-level metal dielectric (IMD) layer. Formed over the IMD layer is a patterned photoresist etch mask layer 38 formed into a pattern 40.

With respect to the substrate 30 shown in FIG. 5, the substrate 30 is analogous or equivalent to the substrate 10 shown in FIG. 1 of the first preferred embodiment of the present invention. Preferably the semiconductor substrate 30 is a silicon semiconductor substrate.

With respect to the microelectronics conductor layer 32 shown in FIG. 5, the mmicroelectronics conductor layer 32 is formed of microelectronics conductor materials including but not limited to microelectronics metals, alloys, conducting compounds, semiconductors formed by methods known in the art of microelectronics fabrications including but not limited to thermal vacuum evaporation, electron beam evaporation, sputtering, chemical vapor deposition, electrodeposition and chemical reaction.

With respect to the planar first low dielectric constant dielectric layer 34 shown in FIG. 5, the planar first low dielectric constant dielectric layer 34 is analogous or equivalent to the first dielectric layer 12 shown in FIG. 1 of the first preferred embodiment of the present invention. Preferably the planar low dielectric constant dielectric layer is formed of hydrogen silsesquioxane (HSQ) polymer spin-on-glass (SOG) dielectric material to a thickness of about 4000 to about 5000 angstroms.

With respect to the second dielectric layer 36 shown in FIG. 5, the second dielectric layer 36 is analogous or equivalent to the second dielectric layer 14 shown in FIG. 1 of the first preferred embodiment of the present invention.

With respect to the patterned photoresist etch mask layer 38 shown in FIG. 5, the patterned photoresist layer 38 is equivalent or analogous to the patterned photoresist etch mask layer 16 shown in FIG. 1 of the first preferred embodiment of the present invention.

Referring now more patricularly to FIG. 6, there is shown a schematic cross-sectional diagram illustrting the result of further processing of the integrated circuit microelectronics fabrication whose schematic cross-sectional diagram is shown in FIG. 5 in accord with the second preferred embodiment of the present invention. Shown in FIG. 6 is an integrated circuit microelectronics fabrication otherwise equivalent to the integrated circuit microelectronics fabrication shown in FIG. 5, but where there has been etched through the dielectric layers 34′ and 36′ the pattern 40 employing the patterned photoresist etch mask layer 38 and an anisotropic reactive ion etching environment 42.

With respect to the anisotropic etching environment 42 shown in FIG. 6, the anisotropic reactive ion etching environment 42 is analogous or equivalent to the anisotropic reactive ion etching environment 20 shown in FIG. 2 of the first preferred embodiment of the present invention.

Referring now more particularly to FIG. 7, there is shown a schematic cross-sectional diagram illustrating the result of further processing of the intergrated circuit microelectronics fabrication whose schematic cross-sectional diagram is shown in FIG. 6 in accord with the second preferred embodiment of the present invention. Shown in FIG. 7 is an integrated circuit microelectronics fabrication otherwise equivalent to the integrated circuit microelectronics fabrication shown in FIG. 6, but where there has been added to the reactive ion etching environment 42 gases to provide exposure of the etched pattern to a final environment 44 to produce passivated surfaces 43 of the etched pattern 40 which are stabilized and show attenuated degradation with respect to subsequent stripping of photoresist etch mask layer.

With respect to the final environment 44 shown in FIG. 7, the final environment 44 is equivalent or analogous to the final environment 22 shown in FIG. 3 of the first preferred embodiment of the present invention.

Referring now more particularly to FIG. 8, there is shown a schematic cross-sectional diagram illustrating the results of further processing of the integrated circuit microelectronics fabrication whose schematic cross-sectional diagram is shown in FIG. 7 in accord with the second preferred embodiment of the present invention. Shown in FIG. 8 is an integrated circuit microelectronics fabrication otherwise equivalent to the integrated circuit microelectronics fabrication shown in FIG. 7, but where there has been stripped the patterned photoresist etch mask layer employing dry plasma ashing and wet chemical methods known in the art of microelectronics fabrication.

Referring now more particularly to FIG. 9, there is shown a schematic cross-sectional diagram illustrating the results of final processing of the integrated circuit microelectronics fabrication whose schematic cross-sectional diagram is shown in FIG. 8. Shown in FIG. 9 is an integrated circuit microelectronics fabrication otherwise equivalent to the integrated circuit microelectronics fabrication shown in FIG. 8, but where there has been formed a second conductive layer over the substrate consisting of a conductor stud 44 and patterned conductot layer 46.

With respect to the second conductor stud 44 and layer 46, the second conductor stud 44 and layer 46 are analogous to the conductor layer 32 shown in FIG. 5 of the second preferred embodiment of the present invention Preferably the second conductor stud layer 44 and patterned conductor layer 46 are formed employing microelectronics conductor layers and methods as are well known in the art of microelectronics fabrication.

Experimental

The benefits and advantages of the present invention are exemplified by the results of measurements of the amount of HSQ dielectric material removed from samples prepared and treated in accord with the method of the present invention employing several variations on the etching and treatment method. Samples of HSQ dielectric spin-on-glass (SOG) dielectric material layers were formed to a thickness of about 4000 to about 5000 angstroms on silicon wafers. The thickness of the HSQ layers was measured by an optical thickness measurement tool. The samples were then exposed to anisotropic reactive ion etching conditions in a magnetically enhanced reactive ion etch (MERIE) system employing the process gases as described in the first preferred embodiment of the present invention. During the final 20 seconds of exposure at 60 degrees centigrade and 500 watts, additional gases were added as follows: (1) Standard procedure employing C₄F₈, CO, N₂ and argon gases; (2) 100 standard cubic centimeters per minute (sccm) argon; (3) 20 standard cubic centimeters per minute (sccm) O₂+100 standard cubic centimeters per minute (sccm) argon; (4) 100 standard cubic centimeters per minute (sccm) N₂; (5) 100 standard cubic centimeters per minute (sccm) N₂+100 standard cubic centimeters per minute (sccm) argon; (6) no exposure to gases. The thickness and composition of the HSQ layers was measured for each group. The samples were then exposed to dry plasma ashing in oxygen and the thickness of the HSQ layers re-measured. Then the samples were treated with PRS wet chemical solvent stripping and the final thickness of the HSQ layers re-measured again. The results are given in Table I below:

TABLE I
Loss of HSQ Layer Thickness Due to Plasma Ashing and PRS Stripping, Angstroms

| Sample | Standard | 100 [_] Ar | 20 [_] O₂ + 100 | 100 [_] N₂ | 100 [_] N₂ + 100 | N |
|---|---|---|---|---|---|---|
| # | (1) | (2) | (3) | (4) | (5) | (6) |
| MERIE+ | — | 161 | 91 | 57 | 43 | — |
| DryAsh | 156 | 0 | 99 | 105 | 60 | 300 |
| PRS | 99 | 42 | 44 | 36 | 43 | 300 |
| Total | 255 | 200 (?) | 234 | 198 | 146 | 600 |

Each of the various added gases provided a degree of stabilization of the HSQ layer with respect to loss during the stripping operations. The most effective added gas treatment was that of the combined nitrogen and argon additional gases employed for Sample 5.

The beneficial effect of the added gas/gases during the final stage of the etching process is believed to be due to a combination of densification of the HSQ layer surface by argon ion bombardment and the formation of an oxidation resistant surface polymer layer due to reaction of N₂ derived species with carbon to form CN-based polymer species.

As is understood by a person skilled in the art, the preferred embodiment of the present invention is illustrative of the present invention rather than limiting of the present invention. Revisions and modifications may be made to methods, materials, structures and dimensions through which are formed microelectronics fabrications in accord with the present invention while still remaining within the spirit and scope of the present invention.

1. A method for semiconductor manufacturing, the method comprising:
forming over a substrate a dual-stack dielectric layer comprising a first dielectric layer and a second dielectric layer wherein the first dielectric layer comprises a dielectric material etchable in an oxygen-containing plasma;
forming over the dual-stack dielectric layer a photoresist etch mask layer;
etching a pattern into and through the second dielectric layer and the first dielectric layer;
adding gases to the etching wherein the gases are employed under a pressure of about 40 mTorr; and
stripping the photoresist etch mask layer by employing dry plasma ashing in oxygen and wet chemical solvent.

2. The method of claim 1 wherein the gases are added near an end of the etching.

3. The method of claim 1 wherein the gases are added at about 1 minute to about 1 minute 30 seconds before an end of the etching.

4. The method of claim 1 wherein the etching is conducted in an anisotropic reactive ion etching environment.

5. The method of claim 1 wherein the first dielectric layer is formed with a hydrogen silsesquioxane (HSQ) polymer spin-on-glass (SOG) dielectric material.

6. The method of claim 1 wherein the second dielectric layer is a silicon containing dielectric layer formed via chemical vapor deposition.

7. A method for etching a pattern within a dual-stack dielectric layer formed upon a substrate during semiconductor manufacturing, the method comprising:
forming over the substrate a dual-stack dielectric layer comprising:
a first dielectric layer formed with a dielectric material etchable in an oxygen-containing plasma; and
a second dielectric layer;
forming over the dual-stack dielectric layer a patterned photoresist etch mask layer;
etching via an anisotropic reactive ion etching environment including perfluorobutene, a pattern through the photoresist etch mask layer and transferring the pattern through the second dielectric layer and the first dielectric layer; and
adding gases in situ to the etching environment to form a plasma and stabilize the surfaces of the etched pattern, wherein the gases are employed under a pressure of about 40 mTorr.

8. The method of claim 7 wherein the substrate is subsequently treated to dry plasma ashing in oxygen and to chemical solvents to strip the photoresist etch mask layer and associated residues.

9. The method of claim 7 wherein the first dielectric layer is formed with a hydrogen silsesquioxane (HSQ) polymer spin-on-glass (SOG) dielectric material.

10. The method of claim 7 wherein the thickness of the first dielectric layer is between about 4000 and about 5000 angstroms.

11. The method of claim 7 wherein the second dielectric layer is a silicon containing dielectric layer formed employing chemical vapor deposition.

12. The method of claim 7 wherein the thickness of the second dielectric layer is between about 3000 and about 4000 angstroms.

13. The method of claim 7 wherein the anisotropic reactive ion etching environment is formed employing perfluoroethylene, carbon monoxide, nitrogen, and argon.

14. The method of claim 7 wherein the gases are nitrogen and argon.

15. The method of claim 7 wherein process conditions for the gases comprise:
power that is between about 450 and about 550 watts;
temperature that is between about 55 and about 65 degrees centigrade; and
time that is between about 20 and about 30 seconds.

16. A method for etching into an inter-level metal dielectric (IMD) layer with reduced inter-level capacitance formed over a substrate during semiconductor manufacturing, the method comprising:
providing a semiconductor substrate with conductor regions formed thereon;
forming over the substrate an IMD layer comprising:
a first planar low dielectric constant dielectric layer including a dielectric material etchable in an oxygen-containing plasma; and
a blanket second dielectric layer for reduced inter-level capacitance;
forming over the IMD layer a patterned photoresist etch mask layer;
etching, while employing an anisotropic reactive ion etching environment including perfluorobutene, a pattern through the IMD layer employing the patterned photoresist etch mask layer;
adding additional gases in situ to the anisotropic etching environment to form a final etching environment to complete the etching of the pattern and stabilize the etched pattern profile wherein the additional gases are employed under a pressure of about 40 mTorr; and
stripping the patterned photoresist etch mask layer employing dry plasma ashing in oxygen and wet chemical solvent methods.

17. The method of claim 10 wherein a patterned second conductor layer is formed over the substrate after the stripping.

18. The method of claim 10 wherein the first planar low dielectric constant dielectric layer is formed employing a hydrogen silsesquioxane (HSQ) polymer spin-on-glass (SOG) dielectric material.

19. The method of claim 10 wherein the second dielectric layer is a silicon oxide dielectric layer formed by a plasma enhanced chemical vapor deposition (PECVD) method.

20. The method of claim 10 wherein the additional gases are nitrogen and argon.
